(19) United States
(12) Patent Application Publication
(10) Pub. No.: US 2014/0305395 A1
(43) Pub. Date: Oct. 16, 2014

(54) Electronic Wizard InfiRun Automobile Ignition Electrical Module

(71) Applicant: Keith Chenard, Somerset, MA (US)

(72) Inventor: Keith Chenard, Somerset, MA (US)

(21) Appl. No.: 14/251,431

(22) Filed: Apr. 11, 2014

Related U.S. Application Data
(60) Provisional application No. 61/810,757, filed on Apr. 11, 2013.

(51) Int. Cl. F02N 19/00

(52) U.S. Cl. CPC F02N 19/001; F02N 2200/102
USPC 123/179.4; 701/102

(57) ABSTRACT

An automobile vehicle ignition device activated with a dashboard button that keeps an automobile engine and vehicle powered accessories running without a key inserted into the ignition cylinder. The ignition device disables the automobile engine once a brake is pressed, preventing movement of the vehicle during operation.

### CROSS REFERENCE TO RELATED APPLICATION

This application claims the benefit of U.S. Provisional Patent Application No. 61/810,757, filed on Apr. 11, 2013, the contents of which are incorporated herein by reference.

### FIELD OF THE INVENTION

The subject invention is an automobile vehicle ignition device that keeps an automobile running without a key inserted into the ignition cylinder.

### BACKGROUND OF INVENTION

Automobile drivers often keep their vehicles unattended with the engine running and the key in the ignition cylinder. Drivers may have several reasons for keeping a vehicle running during an exit, including, but not limited to: preventing engine stalls in cold weather, charging electronic accessories plugged into the vehicle, maintaining the vehicle's internal temperature for passengers with the heating or cooling system, and increasing gasoline usage efficiency with less frequent engine starts and stops.

Furthermore, police vehicles are often left running unattended during traffic stops or at crime scene containment locations. Ambulances are often left running unattended at emergency response location while the EMTs attend to injured or sick people.

Most vehicle engines are started by inserting a key into an ignition cylinder on the steering wheel and turning both of them into a locked “on” position. This locked key must remain in the ignition cylinder for the vehicle's engine to keep running. Significant dangers exist for keeping an unattended vehicle running. The vehicle may present a tempting target for thieves since they may simply enter the vehicle and drive away. A driver may inadvertently leave the keys inside a locked, running vehicle. If the driver locks the running vehicle, the driver must carry an extra set of keys or another unlocking mechanism to prevent being locked out of the running vehicle.

Thus, a device is needed that keeps a vehicle running, but without the need for a key inserted into the ignition cylinder. The device should not allow a thief to easily drive away with the running vehicle.

The subject invention is an automobile vehicle ignition device that keeps an automobile running without a key inserted into the ignition cylinder. This device is not intended to start the vehicle, but instead to keep it running while the driver exits. This device also maintains a vehicle's battery charge when it is activated.

This device is used as a theft deterrent to allow the driver to keep the automobile's keys with them and the automobile still fully functional. This device will remain activated for an infinite amount of time until the automobile's brake is applied.

The safety (theft-deterrent) of this device is the brake pedal itself. When pressed, the unit will shut off and cannot be restarted unless the key is inserted into the ignition and turned into the start position. The automobile also cannot be shifted or stolen, as a driver would need to apply the brakes to shift into gear.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting

The subject invention discloses an ignition system for a vehicle having an engine, comprising an engine starting device; a recipient device on the vehicle that removably receives the engine starting device to start the engine into the engine running position; an ignition harness comprising a capacitor, an electrical circuit, a low current relay, a high current relay, a first ignition, a second ignition, a switching transistor, wherein the ignition harness is operatively attached to the battery of the vehicle, the cold side brake of the vehicle, and the body of the vehicle; a user-actuated device attached to the ignition harness, wherein a user activates the user-actuated device to activate the capacitor, the electrical circuit, and the first ignition to power the ignition harness, further wherein the switching transistor is activated to activate the low current relay, wherein once the low current relay is activated, the engine starting device may be removed from the recipient device while maintaining the engine in the engine running position, further wherein a brake pedal on the vehicle is actuated by the user to break the electrical connection between the ignition harness and the engine, to thereby turn the engine into the engine off position.

The subject invention also discloses an ignition system for a vehicle having an engine, comprising an engine starting device; a recipient device on the vehicle that removably receives the engine starting device to transition the engine into the engine active mode; an ignition harness comprising a capacitor, an electrical circuit, a low current relay, a high current relay, a first ignition, a second ignition, a switching transistor, wherein the ignition harness is operatively attached to the battery of the vehicle, the cold side brake of the vehicle, and the body of the vehicle; a user-actuated device attached to the ignition harness, wherein a user activates the user-actuated device to activate the capacitor, the electrical circuit, and the first ignition to power the ignition harness, wherein the switching transistor is activated to activate the low current relay, further wherein once the low current relay is activated, the engine starting device may be removed from the recipient device while maintaining the engine in the engine active mode, further wherein a brake pedal on the vehicle is actuated by the user to break the current between the ignition harness and the engine, thereby transitioning the engine into the engine dormant mode.

The subject invention further discloses an ignition system for a vehicle having an engine, comprising an engine starting device; a recipient device on the vehicle that removably receives the engine starting device to start the engine into the engine running position; an ignition harness, wherein the ignition harness is operatively attached to the battery of the vehicle, the cold side brake of the vehicle, and the body of the vehicle; a user-actuated device attached to the ignition harness, wherein a user activates the user-actuated device to activate the ignition harness, further wherein once the ignition harness is activated, the engine starting device may be removed from the recipient device while maintaining the engine in the engine running position, further wherein a brake pedal on the vehicle is actuated by the user to break the electrical connection between the ignition harness and the engine, to thereby turn the engine into the engine off position and i) disabling the vehicle from moving; ii) preventing the vehicle from being shifted into drive or neutral positions; and iii) preventing the vehicle from being re-started without an engine starting device.

The subject invention discloses an ignition system for a vehicle having an engine, comprising an engine starting device; a recipient device on the vehicle that removably receives the engine starting device to transition the engine into the engine active mode; an ignition harness, wherein the ignition harness is operatively attached to the battery of the vehicle, the cold side brake of the vehicle, and the body of the vehicle; a user-actuated device attached to the ignition harness, wherein a user activates the user-actuated device to activate the ignition harness, further wherein once the ignition harness is activated, the engine starting device may be removed from the recipient device while maintaining the engine in the engine active mode, further wherein a brake pedal on the vehicle is actuated by the user to break the electrical connection between the ignition harness and the engine, to thereby turn the engine into the engine dormant mode and i) disabling the vehicle from moving; ii) preventing the vehicle from being shifted into drive or neutral positions; and iii) preventing the vehicle from being re-started without an engine starting device.

In embodiments of the subject invention, the ignition harness may have a plurality of powered wires operatively attached to the vehicle battery, engine, the cold side brake, and powered accessories.

In further embodiments of the subject invention, the engine starting device may be a mechanical key inserted into a key cylinder.

In other embodiments of the subject invention, the engine starting device may be an electronic key.

In additional embodiments of the subject invention, the vehicle may be an automobile, truck, bus, or a motorcycle.

In embodiments of the subject invention, the “cylinder” includes any recipient device that interprets the commands or structure of the engine starting device.

In other embodiments of the subject invention, the user actuated device attached to the ignition harness may be a momentary button attached to the dashboard of the vehicle.

In further embodiments of the subject invention, the ignition harness may operate a first powered accessory on the vehicle separately from the engine.

In other embodiments of the subject invention, the ignition harness may operate a second powered accessory on the vehicle separately from the engine.

In embodiments of the subject invention, the ignition harness may have two separate power wires to operate the engine and vehicle powered accessories separately.

In further embodiments of the subject invention, the ignition harness further operates the vehicle powered accessories.

In other embodiments of the subject invention, the ignition harness capacitor may be a 100 nF (nanofarad) capacitor.

The subject invention discloses an ignition system for controlling electrical operation of an engine of a vehicle, the system comprising: an ignition switch for controlling the operation of the engine that enables the engine to operate when the ignition switch is in an ON position; a user-activated ignition harness for making a connection in a parallel electrical power supply circuit to the engine and the cold side brake pedal of the vehicle, wherein a user activates the user-actuated ignition harness to maintain operation of the engine and move the ignition switch to the OFF position, further wherein a brake pedal on the vehicle is actuated by the user to break the electrical connection between the ignition harness and the engine, to thereby turn the engine into the engine off state.

The subject invention also discloses a method for controlling electrical operation of a vehicle, wherein the vehicle comprises an engine and an electrical power supply, comprising: switching an ignition key switch to an ON position when the vehicle engine is running, wherein electrical power is supplied to the engine; activating an ignition harness for making a connection in a parallel electrical power supply circuit to the engine, the electrical power supply, and the cold side brake pedal of the vehicle; removing a key from the ignition key switch by switching the ignition key switch to an OFF position; leaving the vehicle with the engine running and electrical power supplied to the engine; and pressing the brake pedal on the vehicle to break the parallel electrical power supply circuit between the ignition harness and the engine, to thereby turn the engine off.

The subject invention discloses an ignition system for controlling electrical operation of an engine of a vehicle, the system comprising: an ignition switch for controlling the operation of the engine that enables the engine to operate when the ignition switch is in an ON position; a user-activated ignition harness for making a connection in a parallel electrical power supply circuit to the engine and the cold side brake pedal of the vehicle, wherein a user activates the user-actuated ignition harness to maintain operation of the engine and move the ignition switch to the OFF position, further wherein a brake pedal on the vehicle is actuated by the user to break the electrical connection between the ignition harness and the engine, to thereby turn the engine into the engine off state and i) disabling the vehicle from moving; ii) preventing the vehicle from being shifted into drive or neutral positions; and iii) preventing the vehicle from being re-started without the ignition switch being set to the ON position.

The subject invention also discloses a method for controlling electrical operation of a vehicle, wherein the vehicle comprises an engine and an electrical power supply, comprising: switching an ignition key switch to an ON position when the vehicle engine is running, wherein electrical power is supplied to the engine; activating an ignition harness for making a connection in a parallel electrical power supply circuit to the engine, the electrical power supply, and the cold side brake pedal of the vehicle; removing a key from the ignition key switch by switching the ignition key switch to an OFF position; leaving the vehicle with the engine running and electrical power supplied to the engine; and pressing the brake pedal on the vehicle to break the parallel electrical power supply circuit between the ignition harness and the engine, to thereby turn the engine off and i) disabling the vehicle from moving; ii) preventing the vehicle from being shifted into drive or neutral positions; and iii) preventing the vehicle from being re-started without activating the ignition key switch.

In embodiments of the subject invention, the ignition switch may be a mechanical key inserted into a key cylinder.

In further embodiments of the subject invention, the ignition switch may be an electronic key.

In embodiments of the subject invention, the vehicle may be an automobile, truck, bus, or a motorcycle.

In other embodiments of the subject invention, the “cylinder” includes any recipient device that interprets the commands or structure of the engine starting device.

In additional embodiments of the subject invention, the user actuated device attached to the ignition harness may be a momentary button attached to the dashboard of the vehicle.

In further embodiments of the subject invention, the ignition harness may operate a first powered accessory on the vehicle separately from the engine.

In other embodiments of the subject invention, the ignition harness may operate a second powered accessory on the vehicle separately from the engine.

In embodiments of the subject invention, the ignition harness may have two separate power wires to operate the engine and vehicle powered accessories separately.

In embodiments of the subject invention, the ignition harness further operates the vehicle powered accessories.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 is a schematic view of the automobile vehicle ignition device and its electrical connections.

FIG. 2 is a schematic view of the module ignition harness and its electrical connections.

FIG. 3 is a top view of the automobile vehicle ignition device.

### DETAILED DESCRIPTION OF EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

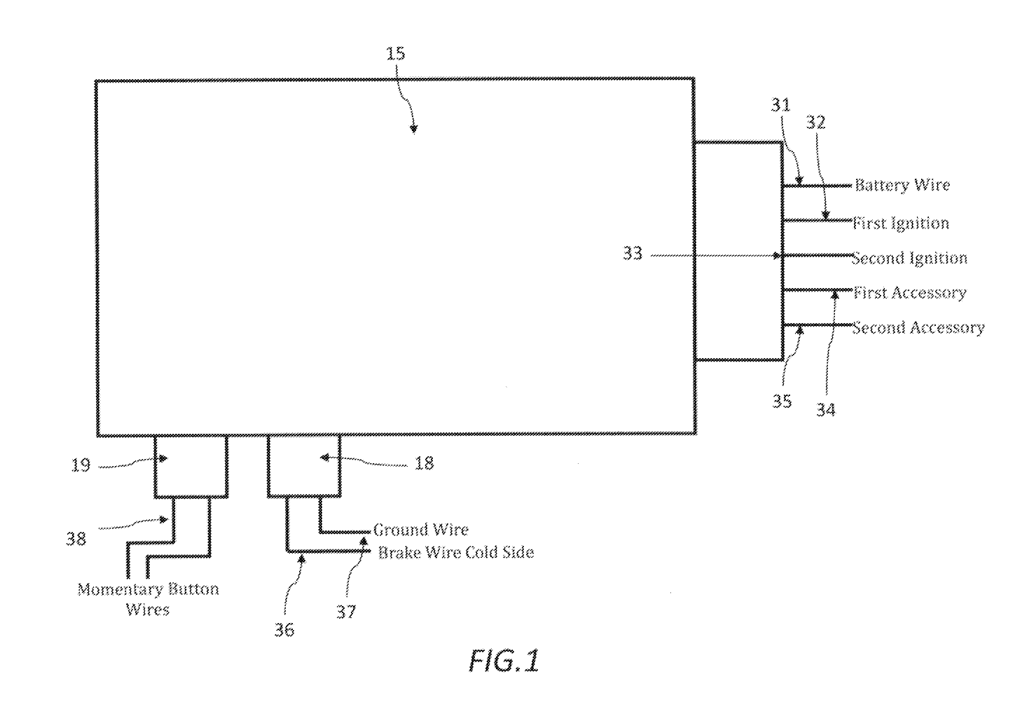

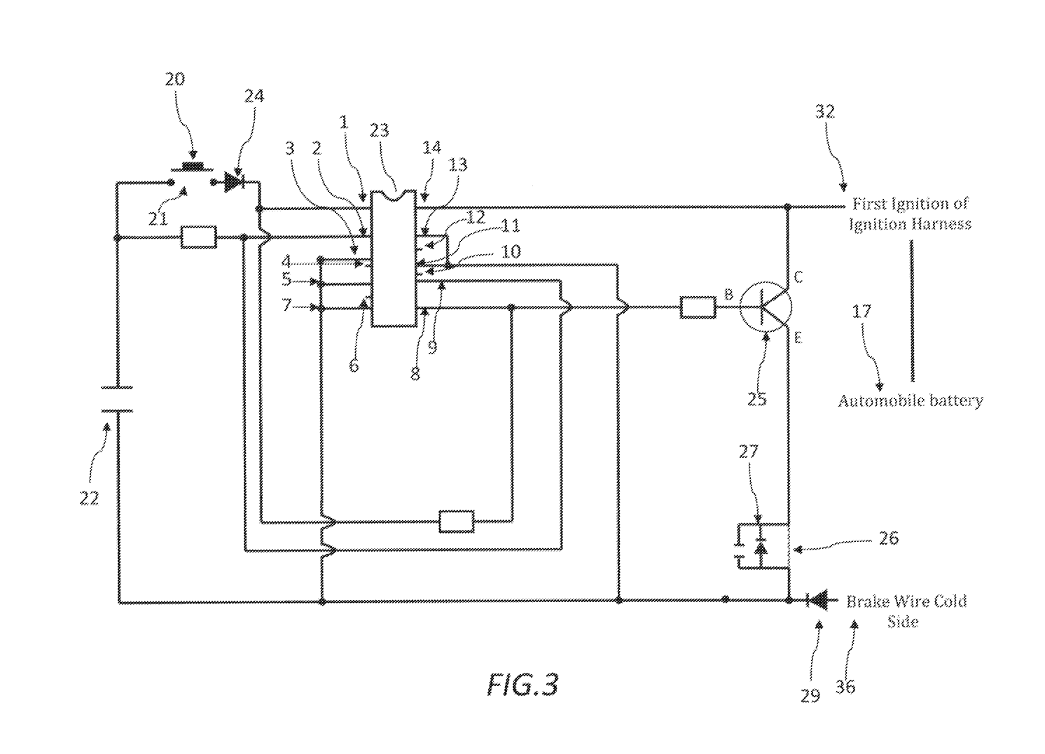

As illustrated in FIGS. 1 and 3, the subject invention is an automobile vehicle ignition device 15 that keeps an automobile running without the key inserted into the ignition cylinder of the vehicle steering wheel.

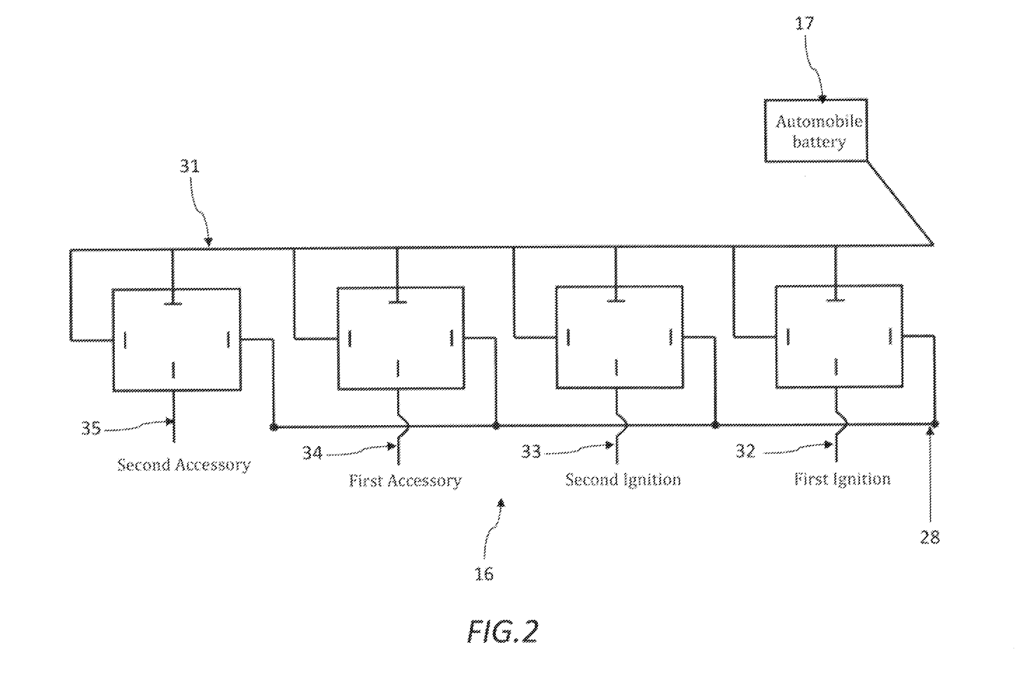

The device 15 is installed into an automobile by first installing a module ignition harness 16 of the device 15 illustrated in FIG. 2, onto the vehicle ignition harness of battery 17 of the automobile.

A red first wire 31 is attached to the automobile battery wire located within the vehicle ignition harness. A blue second wire 32 is connected to a first ignition of the module ignition harness 16. A green third wire 33 is connected to a second ignition of the module ignition harness 16. A white fourth wire 34 may be connected to a first accessory of the module ignition harness 16. A yellow fifth wire 35 may be connected to a second accessory of the module ignition harness 16.

A two-pin plug 18 of the device 15 has a red sixth wire 36 and a green seventh wire 37 extending out from it. The red sixth wire 36 is connected to the cold side of the brake of the automobile. The seventh green wire 37 is connected to the body of the automobile to supply ground to the high current relay 28, which is coming from the low current relay 27.

The other two-pin plug 19 consists of two wires 38 extending out from it. These wires 38 connect to the momentary button 20, which is mounted onto the dashboard at any location preferred by the driver.

An electrical circuit schematic of the device 15 is illustrated in FIG. 3. To activate the device 15, a user presses a momentary button 20, which is mounted onto the automobile's dashboard. Pressing momentary button 20 connects switch 21, allowing the 100 nF (nanofarad) capacitor 22 to activate integrated circuit 23 through diode 24 and pin 1. Integrated circuit 23 also contains pins 2 through 14.

The activation of integrated circuit 23 activates the first ignition of the module ignition harness 16 through second wire 32. This activates the power output for the device 15. Next, a switching transistor 25 is turned on which powers a coil 26 of a low current relay 27. The low current relay 27 switches high current ground to ignition harness relays 28. The ignition harness relays 28 switches on and keeps the automobile running for an extended period of time.

Once a brake pedal is pressed, the cold side of the brake pedal breaks the ground current through the sixth wire 36 and diode 29 to integrated circuit 23 pin numbers 3, 5, 7, 11 and 13. The input ground from integrated circuit 23 and the low current relay 27 coil 26 shuts down the ignition harness relays 28. This deactivates the device 15 causing the automobile to shut down.

In embodiments of the subject invention, the term “wire” may include any suitable electrical current conducting insulated wire, including 12-gauge and 18-gauge wire. In additional embodiments of the subject invention, the term “key” includes any mechanical or electronic engine-starting device. In further embodiments of the subject invention, the term “cylinder” includes any recipient device that interprets the commands or structure of the starting device.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. An ignition system for a vehicle having an engine, comprising an engine starting device; a recipient device on the vehicle that removably receives the engine starting device to transition the engine into the engine active mode; an ignition harness, wherein the ignition harness is operatively attached to the battery of the vehicle, the cold side brake of the vehicle, and the body of the vehicle; a user-actuated device attached to the ignition harness, wherein a user activates the user-actuated device to activate the ignition harness, further wherein once the ignition harness is activated, the engine starting device may be removed from the recipient device while maintaining the engine in the engine active mode, further wherein a brake pedal on the vehicle is actuated by the user to break the electrical connection between the ignition harness and the engine, to thereby turn the engine into the engine dormant mode and i) disabling the vehicle from moving; ii) preventing the vehicle from being shifted into drive or neutral positions; and iii) preventing the vehicle from being re-started without an engine starting device.

2. The ignition system of claim 1, wherein the ignition harness comprises a plurality of powered wires operatively attached to the vehicle battery, engine, the cold side brake, and powered accessories.

3. The ignition system of claim 1, wherein the engine starting device comprises a mechanical key inserted into a key cylinder.

4. The ignition system of claim 1, wherein the engine starting device comprises an electronic key.

5. The ignition system of claim 1, wherein the user actuated device attached to the ignition harness comprises a momentary button attached to the dashboard of the vehicle.

6. The ignition system of claim 1, wherein the ignition harness further operates a first powered accessory on the vehicle separately from the engine.

7. The ignition system of claim 1, wherein the ignition harness further operates a second powered accessory on the vehicle separately from the engine.

8. An ignition system for controlling the electrical operation of an engine of a vehicle, the system comprising: an ignition switch for controlling the operation of the engine that enables the engine to operate when the ignition switch is in an ON position; a user-activated ignition harness for making a connection in a parallel electrical power supply circuit to the engine and the cold side brake pedal of the vehicle, wherein a user activates the user-actuated ignition harness to maintain operation of the engine and move the ignition switch to the OFF position, further wherein a brake pedal on the vehicle is actuated by the user to break the electrical connection between the ignition harness and the engine, to thereby turn the engine into the engine off state.

9. A method for controlling the electrical operation of a vehicle, wherein the vehicle comprises an engine and an electrical power supply, comprising: switching an ignition key switch to an ON position when the vehicle engine is running, wherein electrical power is supplied to the engine; activating an ignition harness for making a connection in a parallel electrical power supply circuit to the engine, the electrical power supply, and the cold side brake pedal of the vehicle; removing a key from the ignition key switch by switching the ignition key switch to an OFF position; leaving the vehicle with the engine running and electrical power supplied to the engine; and pressing the brake pedal on the vehicle to break the parallel electrical power supply circuit between the ignition harness and the engine, to thereby turn the engine off.

10. The method of claim 9, wherein the ignition switch comprises a mechanical key inserted into a key cylinder.

11. The method of claim 9, wherein the ignition switch comprises an electronic key.

12. The method of claim 9, wherein the user actuated device attached to the ignition harness comprises a momentary button attached to the dashboard of the vehicle.

13. The method of claim 9, wherein the ignition harness further operates a first powered accessory on the vehicle separately from the engine.

14. The method of claim 9, wherein the ignition harness further operates a second powered accessory on the vehicle separately from the engine.
